(19) United States
(12) Patent Application Publication
(10) Pub. No.: US 2009/0057553 A1
(43) Pub. Date: Mar. 5, 2009

(54) METHOD AND APPARATUS FOR FOURIER TRANSFORM ION CYCLOTRON RESONANCE MASS SPECTROMETRY

(75) Inventor: Dayan Goodenowe, Saskatoon (CA)

Correspondence Address: NIXON PEABODY LLP - PATENT GROUP, 1100 CLINTON SQUARE, ROCHESTER, NY, 14604, US

(73) Assignee: PHENOMENOME DISCOVERIES INC., Saskatoon, SK (CA)

(21) Appl. No.: 12/066,168

(22) PCT Filed: Sep. 15, 2006
(86) PCT No.: PCT/CA06/01530

§ 371 Date: Aug. 15, 2008

Related U.S. Application Data
(60) Provisional application No. 60/717,378, filed on Sep. 15, 2005.

(51) Int. Cl. B01D 59/44

(52) U.S. Cl. 250/292; 250/282

(57) ABSTRACT

A novel method and apparatus for Fourier Transform Ion Cyclotron Resonance Mass Spectrometry (FTICR-MS). The FTICR-MS apparatus has a pre-ICR mass separation and filtering device capable of receiving ionized molecules with a plurality of mass to charge (M/Z) sub-ranges. The pre-ICR mass separation and filtering device divides the ionized molecules into a plurality of smaller packets, each of the smaller packets is within one of the M/Z sub-ranges. A magnet in the FTICR-MS apparatus provides a controlled magnetic field. A plurality of ion cyclotron resonance (ICR) cells are arranged in series in the controlled magnetic field and operate independently. An ion trapping device connects the pre-ICR mass separation and filtering device, and stores one of the plurality of smaller packets, prior to sending it to one of the plurality of ICR cells.

### FIELD OF THE INVENTION

This invention relates to mass spectrometry. More specifically, this invention relates to Fourier transform ion cyclotron resonance mass spectrometry.

### BACKGROUND OF THE INVENTION

The ability to conduct an analysis of the substance composition in samples is critical to many aspects of day-to-day life such as health care, environmental monitoring. Typically the amount of a specific substance in a complex mixture is determined by various means. For example, in order to measure analytes in a complex mixture, the analytes of interest must be separated from all of the other molecules in the mixture and then independently measured and identified.

Unique chemical and/or physical characteristics of each analyte may be used to resolve the analytes from one another. In chromatography applications, for example, the differences in the polarity of different analytes is used to separate the analytes from one another, and the retention time can be characteristic to a particular analyte. In mass spectrometry, the differences in the M/Z of ionized molecules (analytes) are exploited. Molecules with a different molecular formula generally have a different mass. The differences in mass vary from very large (more than 100 or 1000 atomic mass units (amu)) to very small (less than 1 amu). The smaller the mass difference, the greater is the mass resolution required to separate the ions. High resolution mass spectrometry generally refers to the ability to resolve ions that differ in mass by less than 1 amu, whereas low resolution mass spectrometry generally refers to the ability to resolve ions that differ in mass by greater than 1 amu. The challenge is to be able to perform high resolution mass spectrometry over a very wide mass to charge (M/Z) range, in a reasonable amount of time. Currently, Fourier Transform Ion Cyclotron Mass Spectrometry (FTMS) provides possibly the highest resolution of all types of mass spectrometers, making it most suited to non-targeted complex sample analysis over all other systems.

Chemical applications of Fourier transform ion cyclotron mass spectrometry have been described, for example, in the Accounts of Chemical Research, Vol. 20, page 316, October 1985, which is herewith incorporated by reference in its entirety. Fourier transform mass spectrometry comprises the steps of acquisition of data points as a function of time, followed by discrete Fourier transform to yield the frequency domain spectrum.

Devices that utilize ion cyclotron resonance and measure the number of ions having a particular ion cyclotron resonant frequency are generally referred to as ion cyclotron resonance mass spectrometers.

Ion cyclotron resonance is well known, and provides a sensitive and versatile means for detecting gaseous ions. A moving gaseous ion in the presence of a static magnetic field is constrained to move in a circular orbit in a plane perpendicular to the direction of the magnetic field, and is unrestrained in its motion in directions parallel to the magnetic field. The frequency of this circular motion is directly dependent upon the strength of the magnetic field and the M/Z of the ion. When ions have a cyclotron orbital frequency equal to the frequency of an oscillating electric field that flows at right angles to the magnetic field, they absorb energy from the electric field and are accelerated to larger orbital radii and higher kinetic energy levels. Because only the resonant ions absorb energy from the electric field, they are distinguishable from non-resonant ions upon which the field has substantially no effect. Detection of the absorbed power results in a measurement of the number of resonant gaseous ions of a particular M/Z present in a sample. An ion M/Z spectrum of a particular ionized gas sample is obtained by scanning and detecting. Scanning may be accomplished by varying the frequency of the oscillating electric field, the strength of the applied magnetic field, or both, so as to bring ions of differing M/Z into resonance with the oscillating electric field.

FTMS instruments are ion trapping instruments. All ions that are externally generated must be transferred into the Ion Cyclotron Resonance (ICR) cell. Once in the ICR cell, standard FTMS procedures are then used to resolve and detect the ions contained in the cell. Complex mixtures, such as human plasma, when ionized in the source comprise a spectrum of ions from very small M/Z of 50 or less to large M/Z of 1500 or greater.

Ions of different M/Z have different kinetic energy and therefore different velocities. In the presence of a potential energy gradient, ions of small M/Z have a greater velocity than ions of high M/Z, therefore the time it takes an ion to travel down an ion path is inversely proportional to its mass. Time of Flight (TOF) or sector instruments are designed to exploit this M/Z characteristic. However, this M/Z dependency greatly restricts the M/Z range of analytes (the duty cycle) that can be examined simultaneously by a single FTICR-MS, where ions from the source have to be transferred to and then trapped in the ICR cell prior to their being resolved and detected by passing near detection plates. In FTICR-MS, the masses are not resolved in space or time as with other techniques but only in frequency, the different ions are not detected in different places as with sector instruments or at different times as with time-of-flight instruments but all ions are detected simultaneously over a given period of time.

Referring to FIG. 1 (a), ions are typically trapped external to the ICR cell using a voltage gated potential energy trap such as a radio frequency (RF) only trap 100, comprising a RF-only quadrupole 102, an entrance gate electrode 104 and an end gate electrode 106. Ions 108 entering the entrance gate electrode 104 may be provided by an external ion source 110. Exemplary external ion sources may include, but not limited to: Electrospray Ionization (ESI), Atmospheric Pressure Chemical Ionization (APCI), Matrix Assisted Laser Desorption Ionization (MALDI), and Atmospheric Pressure Photo Ionization (APPI).

Referring to FIGS. 1 (a) and (b), after a certain period of ion accumulation time, during which the ions 108 are trapped by the entrance gate voltage 114 and end gate voltage 116, the end gate 106 is opened and the ions 108 that were trapped in the potential energy well are propelled using a potential energy gradient 118 toward the ICR cell 112.

Referring to FIG. 2 (a), the ions 206 208 are trapped in the ICR cell 202 by applying a high voltage to the entrance plate 210 and the end plate 204 of the cell 202 and after a certain period of time applying a high voltage to the entrance plate 210 of the cell. All ions 206 208 that entered the cell between the time that the RF-only trap 100 was opened and the ICR cell was closed are trapped in the ICR cell and can now be analyzed. This process, however, may result in what is called the “time of flight effect”. Referring to FIG. 2 (c), if the time that the ICR cell 202 is held open is too long, small ions 206 of high velocity will have entered the ICR cell 202, rebounded off of the end plate and escaped back out the entrance plate. Referring to FIG. 2 (b), if this time is too short, large ions of low velocity 208 will not have made it to the ICR cell 202. It is for this reason that only certain M/Z ranges can be trapped in the ICR cell of the FTMS at one time, severely limiting the functionality of current FTMS technology for non-targeted complex sample analysis over wide M/Z ranges. Non-targeted complex sample analysis has been described, for example, in PCT publication WO 01/57518, published on Aug. 9, 2001, which is herewith incorporated by reference in its entirety.

Since FTMS instruments are all ion trapping instruments, there is a limit to the number of ions that can be stored in the ICR cell prior to resolution and detection. Too many ions in the ICR cell adversely affect the resolving power of the instrument and too few ions in the ICR cell adversely affect the sensitivity of detecting the ions in the ICR cell. Therefore, there is an optimal but limited ion population range for FTMS analysis. Maintaining an optimal ion population in the ICR cell is usually accomplished by adjusting the time for which ions are to be collected in the ICR cell or in some pre-ICR ion collection device (for example, an ion guide or ion trap) or, if multiple ion packets are being collected in the ICR cell, the number of these collections is adjusted prior to resolving and detecting the ions. For comprehensive non-targeted complex mixture analysis with a large M/Z range, for example 50-2000, this limited ion population range severely constrains the functionality of the currently available FTMS instruments in non-targeted complex mixture analysis.

Complex mixtures usually comprise a large number of ions with different populations of ions. This results in a limited dynamic range, as large M/Z ranges are analyzed simultaneously, highly populous ions are preferentially detected. The dynamic range can be increased by either increasing the number of ions that can be trapped or by decreasing the M/Z range that is being analyzed. Both options have trade-offs. Increasing the ion population reduces the resolution and accuracy of the instrument and accordingly its ability to correctly identify molecular formulas. Limiting the M/Z ranges being analyzed increases the number of analyses required to examine the whole wide M/Z range.

Typically optimizing ion resolution and detection involves breaking down each complex sample into two or more packets of analytes, ranging from those having a small M/Z to those with a high M/Z, and these packets must be sent individually into the analyzer. This step of sequential analysis of packets greatly extends the amount of time required to examine the complete spectrum of a complex sample. Ultimately this circumstance greatly reduces the high throughput capability and duty cycle of existing FTMS technology.

The resolving power of an FTMS instrument is a function of the number of data points acquired and the length of time that the signal is allowed to decay. In non-targeted complex mixture analysis, the goal is to resolve all of the components from one another and then measure the mass accurately enough to determine the molecular formula of the ion. However, the resolving power and mass accuracy required to achieve this goal is not the same for all M/Z ranges. Ions of lower mass require less resolution and mass accuracy to separate and to identify than ions of higher masses since there are far fewer possible molecular formulas that result in a mass between 100 and 101 than between 800 and 801. Not splitting up the M/Z ranges results either in over resolving peaks at the low M/Z range or under resolving peaks at the high M/Z range.

An example of an ion cyclotron resonance mass spectrometer utilizing such a power absorption detection technique may be found in U.S. Pat. No. 3,390,265 entitled “Ion Cyclotron Resonance Mass Spectrometer Means for Detecting the Energy Absorbed by Resonance Ions”, which is herewith incorporated by reference in its entirety.

Other U.S. patents disclosing ion cyclotron resonance mass spectrometers methods and apparatus, and improvements, include: U.S. Pat. No. 3,446,957 entitled “Ion Cyclotron Resonance Spectrometer Employing Means for Recording Ionization Potentials”; U.S. Pat. No. 3,475,605 entitled “Ion Cyclotron Double Resonance Spectrometer Employing a Series Connection of the Irradiating and Observing RF Sources to the Cell”; U.S. Pat. No. 3,502,867 entitled “Method and Apparatus for Measuring Ion Interrelationships by Double Resonance Mass Spectroscopy”; U.S. Pat. No. 3,505,516 entitled “Ion Cyclotron Resonance Spectrometer Employing an Optically Transparent Ion Collecting Electrode”; U.S. Pat. No. 3,505,517 entitled “Ion Cyclotron Resonance Mass Spectrometer with Means for Irradiating the Sample with Optical Radiation”; U.S. Pat. No. 3,511,986 entitled “Ion Cyclotron Double Resonance Spectrometer Employing Resonance in the Ion Source and Analyzer”; U.S. Pat. No. 3,535,512 entitled “Double Resonance Ion Cyclotron Mass Spectrometer for Studying Ion-Molecule Reactions”; and U.S. Pat. No. 3,677,642 entitled “Ion Cyclotron Resonance Stimulated Low-Discharge Method and Apparatus for Spectral Analysis”, all are herewith incorporated by reference in their entireties.

U.S. Pat. No. 3,742,212 entitled “Method and Apparatus for Pulsed Ion Cyclotron Resonance Spectroscopy”, which is incorporated by reference in its entirety, describes an ion cyclotron resonance mass spectrometer including a single-section ion cyclotron resonance cell. In this cell, ions are formed during a known first time period, allowed to react with neutral molecules for a second time period, and detected in a third time period. The detection of ions of a particular mass to charge ratio is achieved by suddenly changing the resonant frequency of the desired mass to charge ratio ions so as to equate their resonant frequency to the fixed frequency of a marginal oscillator detector. The required sudden change in the cyclotron frequency of the ions of a given mass to charge ratio is achieved either by a sudden change in the value of the applied magnetic field or by a sudden change in the magnitude of the static electric field which is used to “trap” the ions in the ion cyclotron resonance cell. An alternative means for initiating the ion cyclotron resonance detection period is to suddenly change the amplitude of the radio frequency level of the marginal oscillator from zero volts to a higher level. After the ion cyclotron resonance detection period is completed, a “quench” electric field pulse is applied to remove all ions from the ion cyclotron resonance cell.

Ion guides comprising RF-only multipole rod sets such as quadrupoles, hexapoles and octopoles are also known in the art. An alternative type of ion guide or “funnel” comprising a plurality of rings of electrodes of the same size has been described in U.S. Pat. No. 6,891,153 to Bateman, which is herewith incorporated by reference in its entirety.

A cylindrical ion trap (CIT) was described by Langmuir in U.S. Pat. No. 3,065,640, which is incorporated by reference in its entirety, for use as an ion containment device. Subsequently, the use of CITs has focused mainly on ion storage.

Recent experiments (Badman, E. R.; Johnson, R. C.; Plass, W. R.; Cooks, R. G. Anal. Chem. 1998, 70, 4896-4901; Komienko, O.; Reilly, P. T. A.; Whitten, W. B.; Ramsey, J. M. Rapid Commun. Mass Spectrom. 1999, 13, 50-53 and Komienko, O.; Reilly, P. T. A.; Whitten, W. B.; Ramsey, J. M. Rev. Sci. Instrum. 1999, 70, 3907-3909, all are herewith incorporated by reference in their entireties) have shown the CIT to perform well as mass spectrometers/detectors.

Serial ion traps have been described in U.S. Pat. No. 6,794,642 to Bateman et al., which is herewith incorporated by reference in its entirety, as collectors and to split the detected M/Z range for the purpose of increasing the ion volume and dynamic range of a mass spectrometer.

In Bateman the series of ion traps are used to separate the M/Z range into packets, not as detectors of previously created ion packets. The series of ion traps are functionally linked in that ions that are not trapped in one trap spill over into the other trap to overcome the M/Z range limitation known as Low Mass Cut Off (LMCO) inherent with a quadrupole ion trap. The series of ion traps do not reside in a controlled magnetic field. In the Bateman design, a single time of flight (TOF) detection system is used to detect the ions separated by the series of ion traps. Therefore, even though the M/Z range is split into packets, each of these packets must be detected in series, rather than being analyzed in parallel. In addition, the series of ion traps used are not designed to minimize the time of flight effect problem in FTMS analyses.

Therefore, there is a need to shorten the length of time required for the analysis of a wide M/Z range of ions in a single analysis cycle, to enable multiple M/Z range segments to be detected and analyzed simultaneously rather than sequentially, by configuring the ion trap cells independently in series, thereby increasing the duty cycle of the FT-ICR for wide M/Z range applications.

### SUMMARY OF THE INVENTION

In accordance with one embodiment of the present invention, there is provided a Fourier Transform Ion Cyclotron Resonance Mass Spectrometry (FTICR-MS) system with a pre-ICR mass separation and filtering device capable of receiving ionized molecules having a mass to charge ratio (M/Z) range. The M/Z range can be divided into a plurality of M/Z sub-ranges. The pre-ICR mass separation and filtering device divides the ionized molecules in the M/Z range into a plurality of smaller packets, each of the plurality of smaller packets has an M/Z sub-range. A magnet in the FTICR-MS system provides a controlled magnetic field. A plurality of ion cyclotron resonance (ICR) cells are arranged in series in the controlled magnetic field of the magnet. The plurality of ICR cells operate as independent mass resolution and detection devices. An ion trapping device operatively connects to the pre-ICR mass separation and filtering device, for storing one of the smaller packets, prior to sending the one of the smaller mass packets to one of the ICR cells.

In accordance with another aspect of the present invention, there is provided a method of Fourier Transform Ion Cyclotron Resonance Mass Spectrometry comprising the steps of: introducing a sample having a plurality of molecules into an ionization source of a mass spectrometer; ionizing the plurality of molecules resulting in a plurality of ions having a mass to charge ratio (M/Z) range; the M/Z range comprising a plurality of M/Z sub-ranges; passing through a pre-ICR mass separation and filtering device a first packet of ions having a first M/Z sub-range from the plurality of ions; collecting the first packet of ions; transferring the first packet of ions to a first ICR cell using a first time of flight delay appropriate for the first M/Z sub-range; concurrently with the transferring the first packet of ions step passing through said pre-ICR mass separation and filtering device a second packet of ions having a second M/Z sub-range from the plurality of ions; resolving and detecting ions comprised within the first packet of ions using the first ICR cell; collecting the second packet of ions; transferring the second packet of ions to a second ICR cell using a second time of flight delay appropriate for the second M/Z sub-range; resolving and detecting ions comprised within the second packet of ions using the second ICR cell.

In accordance with another aspect of the present invention, there is provided a method of Fourier Transform Ion Cyclotron Resonance Mass Spectrometry comprising the steps of: introducing a sample having a plurality of molecules into an ionization source of a mass spectrometer; ionizing the plurality of molecules resulting in a plurality of ions having a mass to charge ratio (M/Z) range; the M/Z range comprising a plurality of M/Z sub-ranges; passing through a pre-ICR mass separation and filtering device a first packet of ions having a first M/Z sub-range from the plurality of ions; collecting the first packet of ions; transferring the first packet of ions to a first ICR cell; concurrently with the transferring the first packet of ions step using said pre-ICR mass separation and filtering to perform MS/MS operations on a M/Z sub-range from the plurality of ions; resolving and detecting ions comprised within the first packet of ions using the first ICR cell to; collecting the second packet of ions resulting from the MS/MS operation; transferring the second packet of ions to a second ICR cell; and resolving and detecting ions comprised within the second packet of ions using the second ICR cell.

### BRIEF DESCRIPTION OF THE FIGURES

The invention and the illustrated embodiments may be better understood, and the numerous objects, advantages, and features of the present invention and illustrated embodiments will become apparent to those skilled in the art by reference to the accompanying drawings. In the drawings, like reference numerals refer to like parts throughout the various views of the non-limiting and non-exhaustive embodiments of the present invention, and wherein:

FIG. 1 (a) is a schematic illustration of an ion trap;

FIG. 1 (b) illustrates the control of the ion trap using the entrance and end gate voltage;

FIG. 2 (a) (b) (c) illustrate the time of flight effect between the ion trap and the ICR cells;

FIG. 3 is a schematic of a FTICR-MS apparatus in accordance with one embodiment of the present invention;

FIG. 4 depicts the steps of the FTICR-MS method in accordance with one embodiment of the present invention; and

FIG. 5 illustrates the timeline of the steps of the FTICR-MS method in accordance with one embodiment of the present invention.

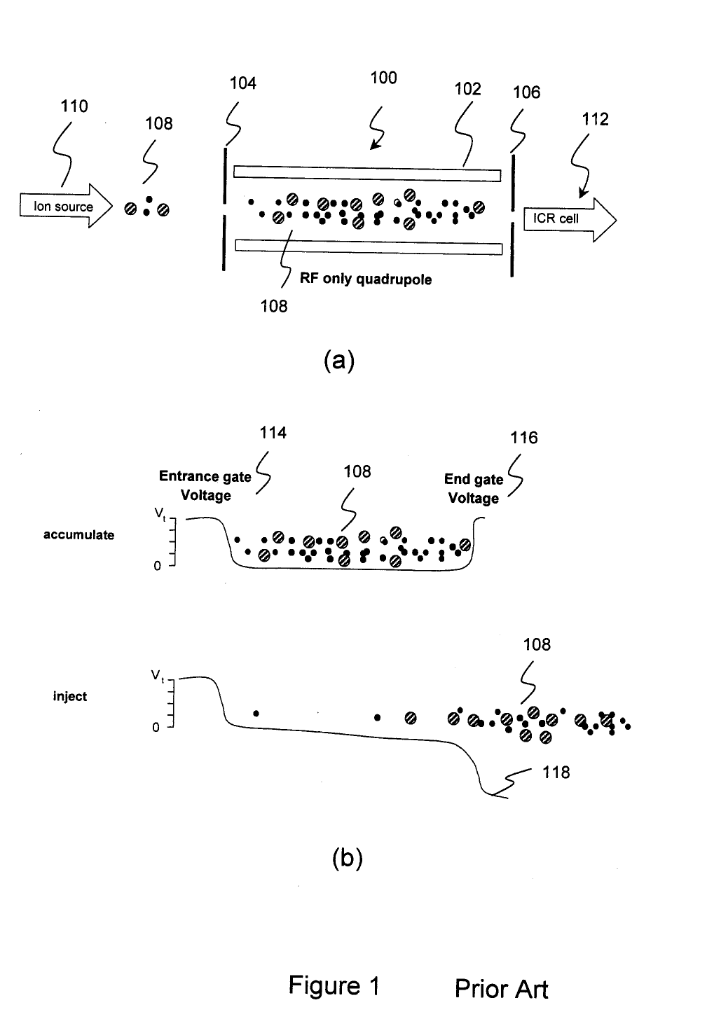

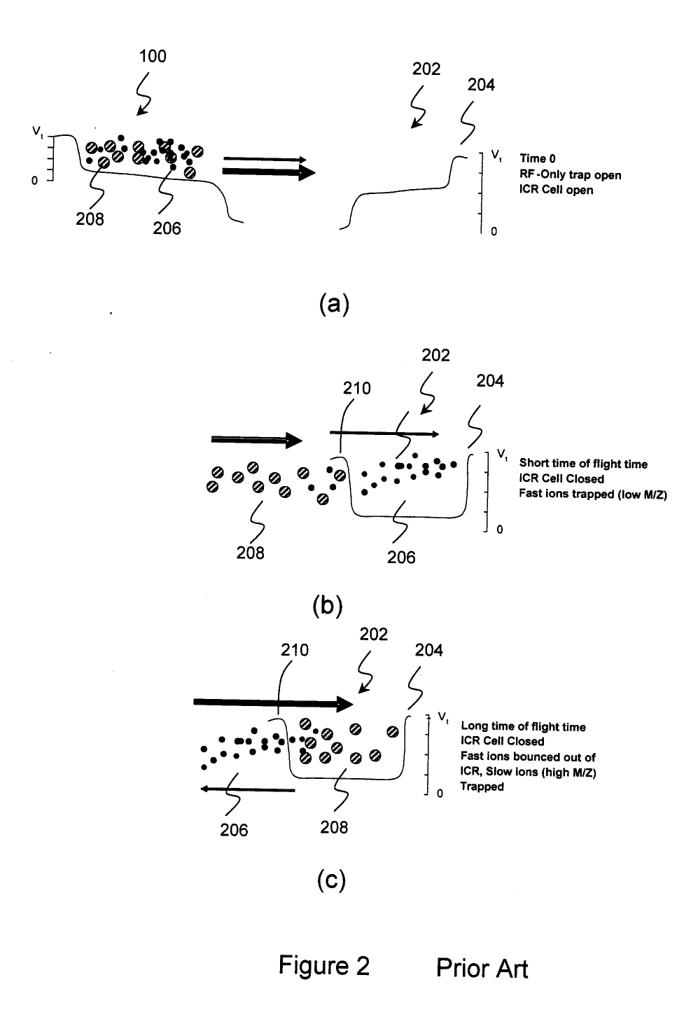

### DETAILED DESCRIPTION OF THE PREFERRED EMBODIMENT

Reference will now be made in detail to some specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

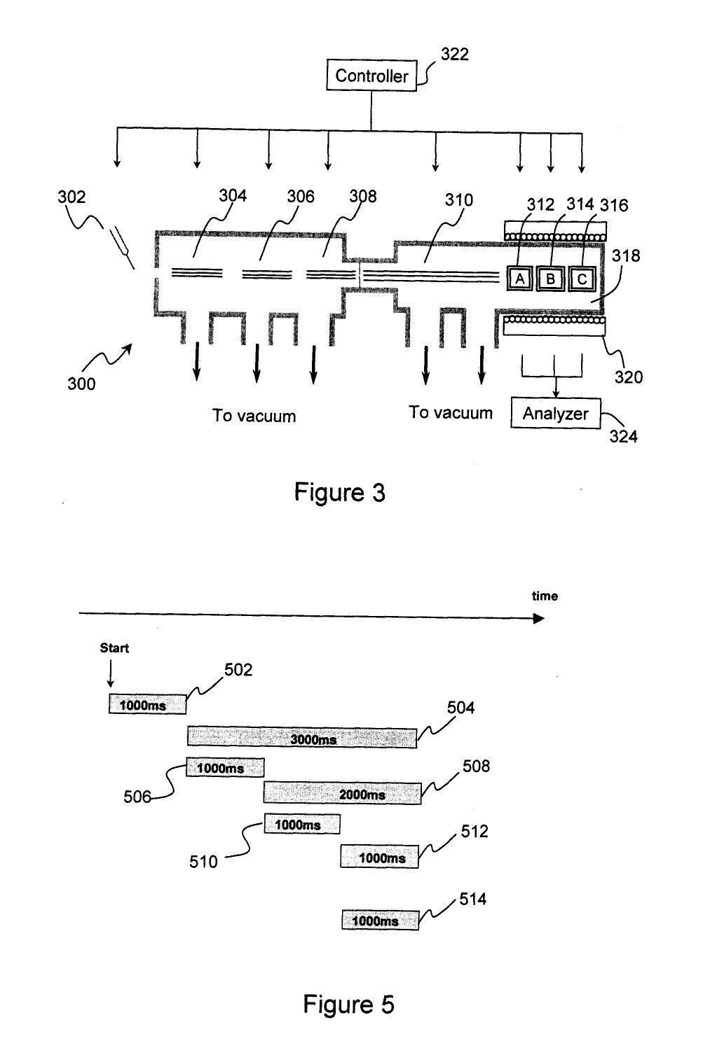

Referring to FIG. 3, in accordance to one embodiment of the present invention an FTMS instrument 300 is shown schematically. An ionization source 302, preferably an external ionization source, is used to ionize the samples, for example but not limited to, a complex biological sample. Ionization methods using different ion source have been described in mass spectrometry literature and are well known. Examples of ionization source include, but not limited to, chemical ionization (CI) source, plasma and glow discharge source, electron impact (EI) source, electrospray ionization (ESI) source, fast-atom bombardment (FAB) source, laser ionization (LIMS) source, matrix-assisted laser desorption ionization (MALDI) source, plasma-desorption ionization (PD) source, an atmospheric pressure photo ionization source, resonance ionization (RIMS) source, secondary ionization (SIMS) source, spark source, and thermal ionization (TIMS) source. All ion sources and configurations may be used in the FTMS instrument of the present invention. An ion guide 304, as non-limiting examples, a quadrupole ion guide, a hexapole ion guide, or an octapole ion guide, is used to transfer the ions from the source 302 to a pre-ICR mass separation and filtering device 306. A heated capillary (not shown) may be included between the source 302 and the ion guide 304 to increase the solvent desolvation. The pre-ICR mass separation and filtering device 306 may be, but not limited to, a quadrupole device, for example, a linear quadrupole; a 3-D quadrupole ion trap; a 2D quadrupole. An ion trapping device 308 may be programmed by the controller 322 to collect the ions in a certain M/Z range. The ion trapping device 308 may be, but not limited to, a quadrupole device, for example, a linear quadrupole; a 3-D quadrupole ion trap; a 2D quadrupole. The pre-ICR mass separation and filtering device 306 and the ion trapping device 308 may be the same type. From the ion trapping device 308 the ions are transferred to one of plurality of ICR cells 312, 314, 316 arranged in series through a second ion guide 310. The second ion guide may be a quadupole ion guide, a hexapole ion guide, an octapole ion guide or an electrostatic lens system. The ICR cells may be an open cylindrical type, an open cubic type, Bruker Infinity cells; or Penning traps. The ICR cells are inside a controlled magnetic field 318, each of the ICR cells is capable of independent resolving and detecting operations. The controlled magnetic field 318 is provided by an FTMS magnet 320, preferably a superconducting magnet. The ion source 302, ion guides 304 and 310, pre-ICR mass separation and filtering device 306, the FTMS magnet 320 and the ICR cells 312, 314, 316 may be controlled by a controller 322. The data generated by the ICR cells are processed by an analyzer 324.

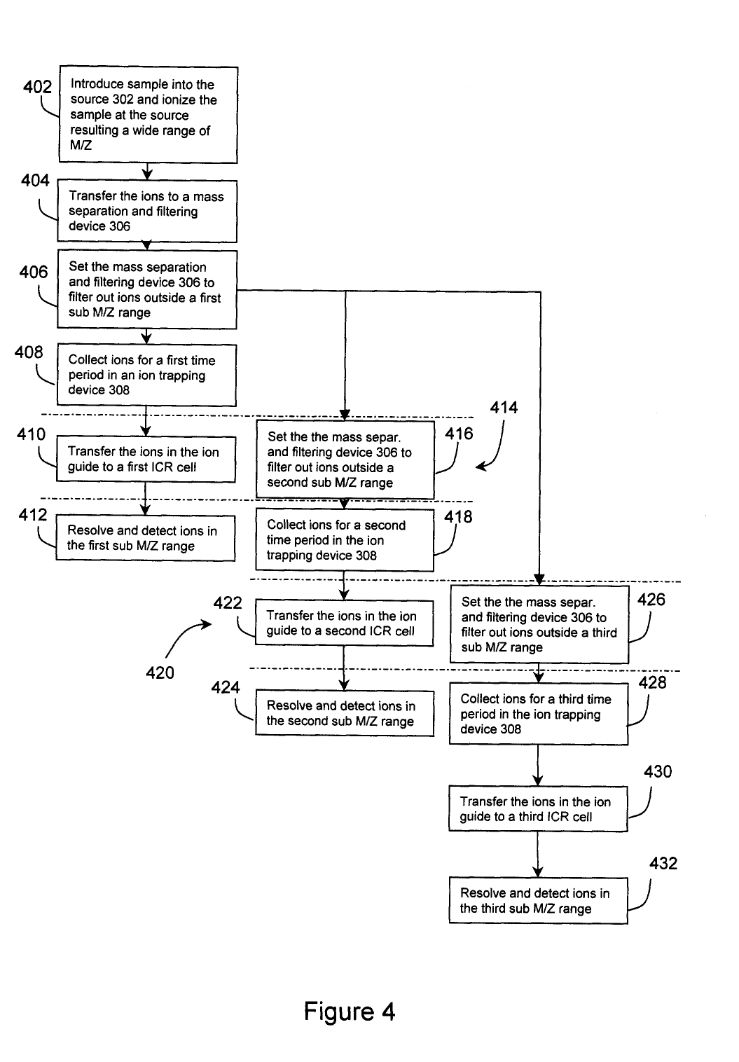

Further referring to FIG. 4, in operation, a complex sample comprising a plurality of molecules is introduced into the source 302 of the FTICR spectrometer 300, the source ionizes the molecules creating ions with a wide range of M/Z charges at step 402, for example 50-2000. At step 404, the ions are transferred to the pre-ICR mass separation and filtering device 306, for example a quadrupole device, through the RF-only ion guide 304. At step 406, the separation and filtering device 306 is set, preferably by the controller, to filter out all ions that do not fall within a first M/Z sub-range of the wide range of the sample, an exemplary M/Z sub-range may be 500-2000. At step 408, the ion trapping device 308 is set to collect ions for a first period of time, for example, 1.0 seconds. The ions from the ion trapping device 308 are transferred to one of the ICR cells, for example ICR cell C 316, at step 410, using a time of flight delay appropriate for the first M/Z sub-range, in the above example, 500-2000. The analyzer 324 is set to resolve and detect ions of the first M/Z sub-range, in this example, 500-2000 using a 2048K data point acquisition method at step 412. The analysis of the M/Z sub-range of 500-2000 may take approximately 3 seconds.

At step 416, the electronics of the pre-ICR mass separation and filtering device 306 are set, preferably by the controller 322, simultaneously 414 with transfer step 410 , to filter out all ions that do not fall within a second M/Z sub-range, for example 200-500. At step 418, the ion trapping device 308 is set to collect ions for a second time period. At step 422, the ions from the ion trapping device 308 are then transferred to a second ICR cell, for example ICR cell B 314, using a time of flight delay appropriate for the second M/Z sub-range, for example, 200-500. The ICR cell B 314 is then set to resolve and detect ions of second M/Z sub-range, in this example, 200-500 using a 1024K data point acquisition method. The analysis of the M/Z sub-range of 200-500 may take approximately 2 seconds.

In one embodiment of the present invention, and simultaneously 420 with the transfer step 422, the pre-ICR mass separation and filtering device 306 are set 426, preferably by the controller 322, to filter out all ions that do not fall within a third M/Z sub-range, for example 50-200. At step 428, the ion trapping device 308 is set to collect ions for a third time period. At step 430, the ions from the ion trapping device 308 are then transferred to a third ICR cell, for example ICR cell A 312, using a time of flight delay appropriate for the third M/Z sub-range, for example, 50-200. The ICR cell A 312 is then set to resolve and detect ions of the third M/Z sub-range, in this example, 50-200 using a 512K data point acquisition method. The analysis of the M/Z sub-range of 50-200 may take approximately 1 second.

FIG. 5 is an exemplary schematic illustration of a duty cycle using three independent ICR cells in a controlled magnetic field as illustrated in FIG. 3, for simultaneously resolving and detecting three sub M/Z ranges of 500-2000, 200-500, and 50-200, respectively.

After start, the pre-ICR mass separation and filtering device 306 is set for M/Z sub-range 500-2000, and ions in M/Z sub-range 500-2000 are collected in ion trapping device 308 for 1000 ms at 502. Then the ion packet is sent to the ICR cell C 316 for resolving and detecting, and a two mega-word file is acquired 504. The pre-ICR mass separation and filtering device 306 is then set for M/Z sub-range 200-500, and ions within the M/Z sub-range 200-500 are collected in the ion trapping device 308 for 1000 ms 506. The collected ion packet is then sent to ICR cell B 314, and a one mega-word file is acquired 508. The pre-ICR mass separation and filtering device 306 is then set for M/Z sub-range 50-200, and ions within the M/Z sub-range 50-200 is then collected in the ion trapping device 308 for 1000 ms. The collected ion packet is then sent to ICR cell A 312, and a 512K file is acquired 512. At 514, the pre-ICR mass separation and filtering device 306 is again set for M/Z sub-range 500-2000, for collecting the ions in that sub-range.

The invention, as described, uses the high resolving power of Fourier Transform Ion Cyclotron Mass Spectrometry (FTMS) to separate all of the components within the mixture that have different M/Z over a wide M/Z range. The use of multiple independent cells arranged in series in the magnetic field of the magnet allows for different M/Z ranges to be sequentially sent into different cells, starting from the cell furthest from the source and ending with the cell closest to the source. This virtually eliminates the time of flight effect that occurs when a researcher attempts to trap an entire M/Z range in the ICR cell. Taking into account the different amount of time that is required to perform different tasks within an FTMS the duty cycle of an experiment can be dramatically increased by performing those tasks that take a long time in the back cell while performing multiple short duration experiments in the cells closest to the source. Since each of the ICR cells are independently controlled, they are all coupled to the path of the ions but decoupled from each other.

The invention utilizes a combination of multiple ICR cells arranged in series in a controlled magnetic field of a magnet, and the ability to divide the entire mass range of interest into packets each having a particular mass range prior to sending these ions to the ICR cells. FTMS experiments that take the longest amount of time can then be performed in the furthest ICR cell and the FTMS experiments that take the least amount of time are performed in the closest ICR cell. Such an instrument increases the utility of FTMS for complex mixture analysis.

The ICR cells may be, in one embodiment, filled with these mass packets starting with the furthest ICR cell and ending with the closest. Utilizing the fact that lower masses need less resolution than higher masses, and that resolution is a function of time and file acquisition size on an FTMS, by filling the back cell first with high masses the high resolution analysis of the high masses can be started, while the closer cells with lower masses which take less time to analyze are filled. Although any mass range can be transferred to any one of the ICR cells, it is therefore preferred that mass packets having the largest masses are sent to the furthest cell and the mass packets having the lowest masses are sent to the closest. In this fashion all experiments may end up being completed approximately at the same time, increasing the efficiency of the duty cycle. This results in a sample high-throughput capacity that is unattainable with prior art FTMS instrument configurations.

A novel FTMS-MS method and apparatus for analyzing complex mixtures of ionized molecules having a wide mass range with high mass resolution and accuracy across the entire mass range is described. In accordance with one embodiment of the present invention, the method and apparatus of the novel FTICR-MS utilizes a plurality of ICR cells, arranged in series, each of which collects a different mass range, this results in an increase of the overall number of ions that can be collected and detected simultaneously in a given analysis. By breaking up the entire mass range of interest into segments, the dynamic range of each segment becomes greater than that if all mass ranges were measured collectively. Each mass segment is small enough such that all M/Z within the packet can be efficiently trapped in the ICR cell. The time of flight effect is therefore significantly reduced.

Furthermore, since each cell is capable of independent operation, all within cell operations that are commonly performed in FTMS operation such as high resolution ion isolation and multiple mass spectrometry (MSn) operations are possible. For example, time consuming MSn operations could be performed in one ICR cell, for example in ICR cell C 316, while relatively faster full scan operations could be performed in a different ICR cell, for example in ICR cell A 312.

In another embodiment of the present invention, different MS experiments could be performed external to the ICR cell and the ions resulting from these different experiments sent to different ICR cells. For example, mass packet 1 could comprise masses resulting from a full scan analysis, for example, performed in the pre-ICR mass separation and filtering device 306, whereas mass packet 2 could comprise masses resulting from the MSn analysis of all or a sub-fraction of the ions comprised in mass packet 1 or even from ions not part of mass packet 1. Alternatively, MSn analyses can be performed externally on different mass ranges and the results sent to different ICR cells for analysis. This is a particularly time saving experiment as the external MSn analyses can be performed in less time than the FTMS analysis.

While particular embodiments of the present invention have been shown and described, changes and modifications may be made to such embodiments without departing from the true scope of the invention.

The embodiments of the invention in which an exclusive property or privilege is claimed are defined as follows:

1. A Fourier Transform Ion Cyclotron Resonance Mass Spectrometry system comprising:
a pre-ICR mass separation and filtering device capable of receiving ionized molecules having a mass to charge ratio, hereinafter referred to as M/Z, range, the M/Z range comprising a plurality of M/Z sub-ranges; the pre-ICR mass separation and filtering device dividing the ionized molecules having the M/Z range into a plurality of smaller packets, each of the plurality of smaller packets having a member of the plurality of M/Z sub-ranges;
a magnet providing a controlled magnetic field;
a plurality of ion cyclotron resonance, hereinafter referred to as ICR, cells arranged in series in the controlled magnetic field of the magnet; the plurality of ICR cells capable of operating independently; and
an ion trapping device operatively connecting the pre-ICR mass separation and filtering device, for storing one of the plurality of smaller packets, prior to sending the one of the plurality of smaller mass packets to one of the plurality of ICR cells.

2. The system according to claim 1 further comprising an ionization source.

3. The system according to claim 2 further comprising an ion guide for receiving the ionized molecules from the ionization source, and delivering the ionized molecules to the pre-ICR mass separation and filtering device.

4. The system according to claim 3, further comprising a second ion guide for transferring the one of the plurality of smaller packets from the ion trapping device to one of the plurality cells ICR cells.

5. The system according to claim 1 further comprising an external ionization source, wherein the external ionization source is selected from the group consisting of chemical ionization (CI) source, plasma and glow discharge source, electron impact (EI) source, electrospray ionization (ESI) source, fast-atom bombardment (FAB) source, laser ionization (LIMS) source, matrix-assisted laser desorption ionization (MALDI) source, plasma-desorption ionization (PD) source, an atmospheric pressure photo ionization source, resonance ionization (RIMS) source, secondary ionization (SIMS) source, spark source, and thermal ionization (TIMS) source.

6. The system according to claim 1 wherein the magnet is a superconducting magnet.

7. The system according to claim 1 wherein the ICR cells are selected from the group consisting of open cylindrical type, open cubic type, Bruker Infinity cells; Penning traps; and a combination thereof.

8. The system according to claim 1 wherein the pre-ICR mass separation and filtering device is selected from the group consisting of a linear quadrupole; a 3-D quadrupole ion trap; a 2D quadrupole ion trap.

9. The system according to claim 1 wherein the ion trapping device is selected from the group consisting of a linear quadrupole; a 3-D quadrupole ion trap; a 2D quadrupole ion trap.

10. The system according to claim 1 wherein the pre-ICR mass separation and filtering device is based on a time of flight principle.

11. The system according to claim 1 wherein the first ion guide selected from the group consisting of a quadrupole ion guide, a hexapole ion guide, an octapole ion guide.

12. The system according to claim 1 further comprising a heated capillary between the source and the first ion guide.

13. The system according to claim 1 wherein the second ion guide is selected from the group consisting of a quadupole ion guide, a hexapole ion guide, an octapole ion guide and an electrostatic lens system.

14. A method of Fourier Transform Ion Cyclotron Resonance Mass Spectrometry comprising the steps of:
a) introducing a sample having a plurality of molecules into an ionization source of a mass spectrometer;
b) ionizing the plurality of molecules resulting in a plurality of ions having a mass to charge ratio, hereinafter referred to as M/Z, range; the M/Z range comprising a plurality of M/Z sub-ranges;
c) passing through a pre-ICR mass separation and filtering device a first packet of ions having a first M/Z sub-range from the plurality of ions;
d) collecting the first packet of ions;
e) transferring the first packet of ions to a first ICR cell using a first time of flight delay appropriate for the first M/Z sub-range;
f) concurrently with the transferring the first packet of ions step (e) passing through said pre-ICR mass separation and filtering device a second packet of ions having a second M/Z sub-range from the plurality of ions;
g) resolving and detecting ions comprised within the first packet of ions using the first ICR cell;
h) collecting the second packet of ions;
i) transferring the second packet of ions to a second ICR cell using a second time of flight delay appropriate for the second M/Z sub-range; and
j) resolving and detecting ions comprised within the second packet of ions using the second ICR cell.

15. The method according to claim 14, further comprising the steps of:
k) concurrently with the transferring the second packet of ions step (i) passing through a pre-ICR mass separation and filtering device a third packet of ions having a third M/Z sub-range from the plurality of ions;
l) collecting the third packet of ions;
m) transferring the third packet of ions to a third ICR cell using a third time of flight delay appropriate for the third M/Z sub-range; and
n) resolving and detecting ions comprised within the third packet of ions using the third ICR cell.

16. The method according to claim 14 wherein ICR cells are connected in series and in a controlled magnetic field.

17. The method according to claim 14 wherein the first ICR cell is located further from the ionization source than the second ICR cell, and wherein the first M/Z sub-range is greater than the second M/Z sub-range.

18. The method according to claim 14 wherein the ionization source is selected from the group consisting of chemical ionization (CI) source, plasma and glow discharge source, electron impact (EI) source, electrospray ionization (ESI) source, fast-atom bombardment (FAB) source, laser ionization (LIMS) source, matrix-assisted laser desorption ionization (MALDI) source, plasma-desorption ionization (PD) source, an atmospheric pressure photo ionization source, resonance ionization (RIMS) source, secondary ionization (SIMS) source, spark source, and thermal ionization (TIMS) source.

19. The method according to claim 14 wherein the ICR cells are selected from the group consisting of open cylindrical type, open cubic type, Bruker Infinity cells; Penning traps; and a combination thereof.

20. A method of Fourier Transform Ion Cyclotron Resonance Mass Spectrometry comprising the steps of:
a) introducing a sample having a plurality of molecules into an ionization source of a mass spectrometer;
b) ionizing the plurality of molecules resulting in a plurality of ions having a mass to charge ratio, hereinafter referred to as M/Z, range; the M/Z range comprising a plurality of M/Z sub-ranges;
c) passing through a pre-ICR mass separation and filtering device a first packet of ions having a first M/Z sub-range from the plurality of ions;
d) collecting the first packet of ions;
e) transferring the first packet of ions to a first ICR cell;
f) concurrently with the transferring the first packet of ions step (e) using said pre-ICR mass separation and filtering to perform MS/MS operations on a M/Z sub-range from the plurality of ions;
g) resolving and detecting ions comprised within the first packet of ions using the first ICR cell to;
h) collecting the second packet of ions resulting from the MS/MS operation in step (f);
i) transferring the second packet of ions to a second ICR cell; and
j) resolving and detecting ions comprised within the second packet of ions using the second ICR cell.
